(19) United States
(12) Patent Application Publication
(10) Pub. No.: US 2026/0038795 A1
(43) Pub. Date: Feb. 5, 2026

(54) SYSTEMS AND METHODS OF FORMING SEMI-SOLID ELECTRODES

(71) Applicant: 24M Technologies, Inc., Cambridge, MA (US)

(72) Inventor: Glenn JORDAN, Harvard, MA (US)

(21) Appl. No.: 19/285,462

(22) Filed: Jul. 30, 2025

Related U.S. Application Data
(60) Provisional application No. 63/678,229, filed on Aug. 1, 2024.

(51) Int. Cl. H01M 4/04

(52) U.S. Cl. CPC H01M 4/0409

(57) ABSTRACT

Embodiments described herein relate to blade assemblies for shaping of semi-solid electrodes. In some aspects, a blade assembly can include a doctor blade and a mounting frame attached to the doctor blade. The mounting frame includes a blade attachment coupled to a first portion of the doctor blade, a first flexure element, and a second flexure element coupled to the blade attachment. The mounting frame further includes a linear output connector coupled to the first flexure element and the second flexure element. The linear output connector imparts a tensile force to the first flexure element when at a first elevation and a tensile force to the second flexure element when at a second elevation, the second elevation lower than the first elevation. The mounting frame further includes a camshaft that imparts vertical motion to the linear output connector and an actuator that imparts rotational motion to the camshaft.

### CROSS-REFERENCE TO RELATED APPLICATIONS

This application claims priority to and the benefit of U.S. Provisional Patent Application No. 63/678,229, filed Aug. 1, 2024, and titled, “Systems and Methods of Forming Semi-Solid Electrodes,” the disclosure of which is hereby incorporated by reference in its entirety.

### TECHNICAL FIELD

Embodiments described herein relate to semi-solid electrode production and formation and apparatus for implementing the same.

### BACKGROUND

Semi-solid electrodes can have high densities and high solids loading. When casting such materials from orifices or nozzles, the high density, viscosity, and/or solids loading creates a large force and rotational moment in the direction of casting. Machinery involved with the casting process can experience problems, particularly with regards to the thickness uniformity of the electrodes produced. This can be due to oscillations or jolts due to the high casting force. Conveyor devices that transport semi-solid electrode material (and materials between the conveyor device and the semi-solid electrode material) can also be uneven along their width, with one side slightly higher than the other side. This can cause non-uniformity of thickness along the width of the semi-solid electrode material, ultimately affecting the performance and safety of the electrochemical cell. Adjusting electrode shaping devices to account for such non-uniformities with high precision and timeliness can significantly improve the width uniformity of cast semi-solid electrodes.

### SUMMARY

Embodiments described herein relate to blade assemblies for shaping of semi-solid electrodes. In some aspects, a blade assembly can include a blade (also referred to herein as a “doctor blade”) and a mounting frame attached to the doctor blade. The mounting frame includes a blade attachment coupled to a first portion of the doctor blade, a first flexure element, and a second flexure element coupled to the blade attachment. The mounting frame further includes a linear output connector coupled to the first flexure element and the second flexure element. The linear output connector imparts a tensile force to the first flexure element when at a first elevation and a tensile force to the second flexure element when at a second elevation, the second elevation lower than the first elevation. The mounting frame further includes a camshaft that imparts vertical motion to the linear output connector and a actuator that imparts rotational motion to the camshaft.

In some aspects, a method includes: casting a semi-solid electrode material onto a conveyor via a casting nozzle; advancing the semi-solid electrode material along the conveyor; contacting semi-solid electrode material with a doctor blade; and rotating a coupler to induce a vertical translation of a first portion of the doctor blade relative to a second portion of the doctor blade, such that the doctor blade has a non-uniform vertical position along a width of the doctor blade while contacting the semi-solid electrode material.

In some aspects, a blade assembly includes: a blade; a mounting frame, the mounting frame including: a linear output connector operably coupled to a first portion of the blade, the linear output connector configured to impart vertical translations to the first portion of the blade, such that the first portion of the blade is at a different elevation from a second portion of the blade; a shaft operably coupled to the linear output connector and configured to rotate to impart vertical motion to the linear output connector; and an actuator operably coupled to the shaft and configured to impart rotational motion to the shaft.

### BRIEF DESCRIPTION OF THE DRAWINGS

FIG. 1 is a block diagram of a blade assembly for forming a semi-solid electrode, according to an embodiment.

FIGS. 2A-2B are illustrations of a casting nozzle for casting a semi-solid electrode material, according to an embodiment.

FIGS. 3A-3N are illustrations of a blade assembly for forming a semi-solid electrode, according to an embodiment.

FIG. 4 is a flow diagram of a method of forming a semi-solid electrode, according to an embodiment.

### DETAILED DESCRIPTION

Embodiments described herein relate to dynamic blade systems that utilize cams to induce vertical movement of the blade for the shaping of semi-solid electrode materials. Mechanisms described herein utilize conjugate cams and cam follower systems that positively drive shaping blades or doctor blades upward and/or downward. The cam mechanisms described herein can exhibit desmodromic functionality in controlling the doctor blade. Such systems perform with high precision and low margin of error. Cam systems described herein can be used to cause blades coupled thereto to cant or rock. This aids in compensating for non-uniformities in the level of a conveyor (e.g., due to rocking of the conveyor which may include pallets mounted on pivot mounts) that conveys the semi-solid electrode under the doctor blade. Flexure systems can be included in the cam output to minimize or eliminate backlash of the doctor blade (i.e., the doctor blade does not deviate from the desired vertical position). In other words, high shear forces encountered during semi-solid casting can be handled by the cam mechanism, while exhibiting zero backlash in the output of the doctor blade motion.

Embodiments described herein can have varying hub or knuckle designs near the outer edge of the doctor blade. This can allow the doctor blade to move perpendicular to the direction of web or conveyor travel while simultaneously preventing blade rocking in the web travel or conveyance direction. Embodiments described herein include actuators (e.g., servo motors and/or servo drives) and camshafts incorporated into mechanisms that deliver linear motion to doctor blades or sections of doctor blades. Rotational motion of the camshaft corresponds to linear motion of the doctor blade. In some embodiments, each arcsecond of camshaft rotation can correspond to an equal vertical motion of the doctor blade. High resolution positioning (i.e., sub-micron resolution) ensures dynamic control of the cam mechanism, translating to low coat weight variations in a unit cell semi-solid coating. Embodiments described herein exhibit high accuracy, anti-backlash properties, and high dynamic response capabilities.

In some embodiments, electrode casting methods and apparatus described herein can incorporate aspects of the casting methods described in U.S. Pat. No. 11,139,467 (the '467patent), filed Jul. 9, 2019 and titled “Continuous and Semi-continuous Methods of Semi-solid Electrode and Battery Manufacturing,” the disclosure of which is hereby incorporated by reference in its entirety. In some embodiments, electrode casting methods and apparatus described herein can incorporate aspects of the casting methods described in U.S. Pat. No. 12,125,984 (the '984patent), filed Oct. 12, 2021 and titled “Methods of Continuous and Semi-Continuous Production of Electrochemical Cells,” the disclosure of which is hereby incorporated by reference in its entirety. In some embodiments, electrode casting methods and apparatus described herein can incorporate aspects of the casting methods described in U.S. Patent Publication No. 2023/0327068 (the '068 publication), filed Apr. 12, 2023 and titled “Continuous and Semi-continuous Methods of Electrode and Electrochemical Cell Production,” the disclosure of which is hereby incorporated by reference in its entirety.

Electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

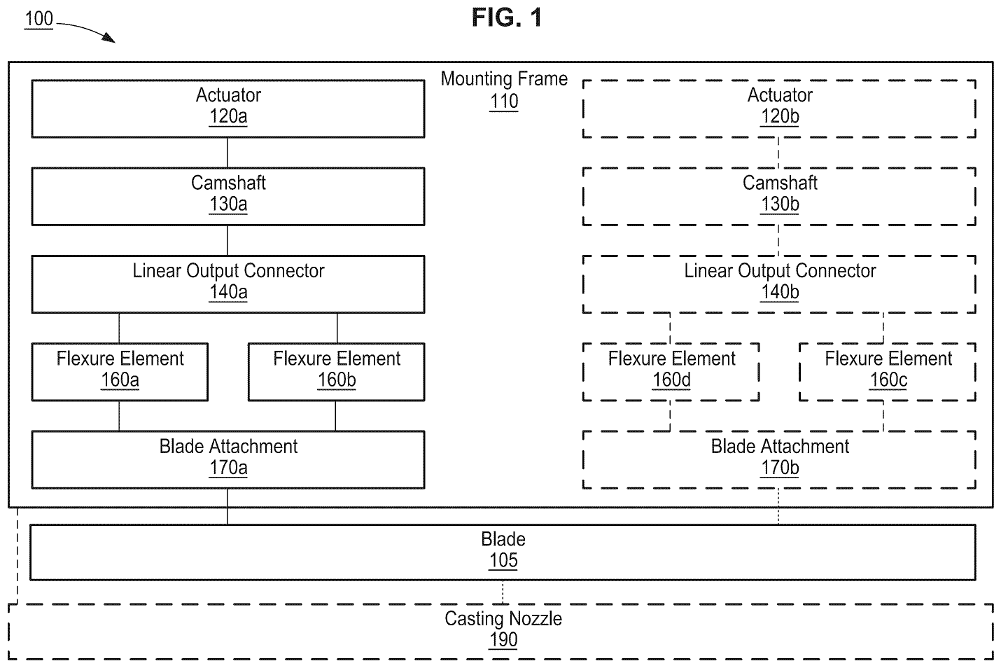

FIG. 1 is a block diagram of a blade assembly 100 for shaping semi-solid electrodes, according to an embodiment. As shown, the blade assembly 100 includes a doctor blade 105 and a mounting frame coupled to the doctor blade 105. As shown, the mounting frame 110 includes an actuator 120a (e.g., a servo drive), a coupler 130a (also referred to herein as “shaft 130a”), a linear output connector 140a, a flexure element 160a, a flexure element 160b, and a blade attachment 170a. In some embodiments, the mounting frame 110 can include an additional actuator 120b, an additional shaft 130b, an additional linear output connector 140b, additional flexure elements 160c, 160d, and an additional blade attachment 170b. In some embodiments, the actuator 120a, the shaft 130a, the linear output connector 140a, the flexure elements 160a, 160b, and the blade attachment 170a can be incorporated into a first arm, while the actuator 120b, the shaft 130b, the linear output connector 140b, the flexure elements 160c, 160d, and the blade attachment 170b can be incorporated into a second arm. In some embodiments, the blade assembly 100 includes a casting nozzle 190. In some embodiments, the casting nozzle can be coupled to the doctor blade 105. In some embodiments, the casting nozzle 190 can be coupled to the mounting frame 110.

In use, the actuator 120a provides rotational movement to the shaft 130a. The shaft 130a (or cams coupled thereto) is operably coupled to the linear output connector 140a, such that rotational motion of the shaft 130a induces linear vertical motion of the linear output connector 140a. The vertical motion of the linear output connector 140a induces vertical motion of the blade attachment 170a with one of the flexure elements 160a, 160b being in tension, depending on the vertical position of the linear output connector 140a relative to the blade attachment 170a. The blade attachment 170a acts as a connection piece between the mounting frame 110 and the doctor blade 105. In some embodiments, the components of the second arm (i.e., the actuator 120b, the shaft 130b, the linear output connector 140b, the flexure elements 160c, 160d, and the blade attachment 170b) can function the same or substantially similar to the components of the first arm (the actuator 120a, the shaft 130a, the linear output connector 140a, the flexure elements 160a, 160b, and the blade attachment 170a), and may also be substantially similar in structure thereto.

As shown, the doctor blade 105 is coupled to the mounting frame 110. The doctor blade 105 is adjusted to keep the thickness of the semi-solid electrode material uniform along a width of the semi-solid electrode and to a desired thickness value. In some embodiments, the doctor blade 105 can be composed of metal, steel, ceramic, aluminum, stainless steel, or any other suitable material or combinations thereof.

The mounting frame 110 attaches to the doctor blade 105 and induces vertical motion of either side of the doctor blade (e.g., via slidable connections to the doctor blade 105). In some embodiments, the mounting frame 110 can include a single arm. In some embodiments, the mounting frame 110 can include two arms appended or coupled to either side of the mounting frame 110 along the width of the doctor blade 105. In some embodiments, the mounting frame 110 can include additional arms, for example, for supporting the doctor blade 105 or movement control of the doctor blade 105 on various points along the width of the doctor blade 105. In some embodiments, the mounting frame 110 can include about 1, about 2, about 3, about 4, about 5, about 6, about 7, about 8, about 9, about 10, or at least about 10 arms, inclusive of all values and ranges therebetween. The mounting frame 110 is able have a tilted or canted orientation via vertical movement of the first arm (e.g., relative to the second arm, or relative to a fixed point in the case where the mounting frame 110 does not include a second arm). In some embodiments, some portions of the mounting frame 110 are vertically mobile, while some portions of the mounting frame 110 remain vertically stable (i.e., as reference points).

Regarding the functionality of the mounting frame 110, the actuators 120a, 120b apply rotational motion to the shafts 130a, 130b. Any suitable actuators can be used, for example, servo motors, servo drives, linear and/or rotational actuators, stepper motors, etc. In some embodiments, the actuators 120a, 120b can induce rotational speeds in the shafts 130a, 130b of at least about 20 rpm, at least about 30 rpm, at least about 40 rpm, at least about 50 rpm, at least about 60 rpm, at least about 70 rpm, at least about 80 rpm, at least about 90 rpm, at least about 100 rpm, at least about 200 rpm, at least about 300 rpm, at least about 400 rpm, at least about 500 rpm, at least about 600 rpm, at least about 700 rpm, at least about 800 rpm, at least about 900 rpm, at least about 1,000 rpm, at least about 2,000 rpm, at least about 3,000 rpm, at least about 4,000 rpm, or at least about 5,000 rpm. In some embodiments, the actuators 120a, 120b can induce rotational speeds in the shafts 130a, 130b of no more than about 6,000 rpm, no more than about 5,000 rpm, no more than about 4,000 rpm, no more than about 3,000 rpm, no more than about 2,000 rpm, no more than about 1,000 rpm, no more than about 900 rpm, no more than about 800 rpm, no more than about 700 rpm, no more than about 600 rpm, no more than about 500 rpm, no more than about 400 rpm, no more than about 300 rpm, no more than about 200 rpm, no more than about 100 rpm, no more than about 90 rpm, no more than about 80 rpm, no more than about 70 rpm, no more than about 60 rpm, no more than about 50 rpm, no more than about 40 rpm, or no more than about 30 rpm. Combinations of the above-referenced rotational speeds are also possible (e.g., at least about 20 rpm and no more than about 6,000 rpm or at least about 100 rpm and no more than about 1,000 rpm), inclusive of all values and ranges therebetween. In some embodiments, the actuators 120a, 120b can induce rotational speeds in the shafts 130a, 130b of about 20 rpm, about 30 rpm, about 40 rpm, about 50 rpm, about 60 rpm, about 70 rpm, about 80 rpm, about 90 rpm, about 100 rpm, about 200 rpm, about 300 rpm, about 400 rpm, about 500 rpm, about 600 rpm, about 700 rpm, about 800 rpm, about 900 rpm, about 1,000 rpm, about 2,000 rpm, about 3,000 rpm, about 4,000 rpm, about 5,000 rpm, or about 6,000 rpm.

The shafts 130a, 130b rotate to induce vertical motion in the linear output connectors 140a, 140b. In some embodiments, the shaft 130a and/or the shaft 130b can include a camshaft. Specifically, the shafts 130a, 130b (or cams attached thereto) can contact the linear output connectors 140a, 140b and induce vertical motion in the linear output connectors 140a, 140b, depending on the rotational orientation of the shafts 130a, 130b. In some embodiments, the shafts 130a, 130b can rotate between fixed rotational orientations rather than making full revolutions. For example, the shafts 130a, 130b can have ranges of motion of less than 360 degrees. In some embodiments, the shafts 130a, 130b can be shaped to push against an upper surface of the linear output connectors 140a, 140b in some orientations and a lower surface of the linear output connectors 140a, 140b in other orientations.

In some embodiments, the shafts 130a, 130b can have a rotational range of motion of at least about 10 degrees, at least about 20 degrees, at least about 30 degrees, at least about 40 degrees, at least about 50 degrees, at least about 60 degrees, at least about 70 degrees, at least about 80 degrees, at least about 90 degrees, at least about 100 degrees, at least about 110 degrees, at least about 120 degrees, at least about 130 degrees, at least about 140 degrees, at least about 150 degrees, at least about 160 degrees, at least about 170 degrees, at least about 180 degrees, at least about 190 degrees, at least about 200 degrees, at least about 210 degrees, at least about 220 degrees, at least about 230 degrees, at least about 240 degrees, at least about 250 degrees, at least about 260 degrees, at least about 270 degrees, at least about 280 degrees, or at least about 290 degrees. In some embodiments, the shafts 130a, 130b can have a rotational range of motion of no more than about 300 degrees, no more than about 290 degrees, no more than about 280 degrees, no more than about 270 degrees, no more than about 260 degrees, no more than about 250 degrees, no more than about 240 degrees, no more than about 230 degrees, no more than about 220 degrees, no more than about 210 degrees, no more than about 200 degrees, no more than about 190 degrees, no more than about 180 degrees, no more than about 170 degrees, no more than about 160 degrees, no more than about 150 degrees, no more than about 140 degrees, no more than about 130 degrees, no more than about 120 degrees, no more than about 110 degrees, no more than about 100 degrees, no more than about 90 degrees, no more than about 80 degrees, no more than about 70 degrees, no more than about 60 degrees, no more than about 50 degrees, no more than about 40 degrees, no more than about 30 degrees, or no more than about 20 degrees. Combinations of the above-referenced ranges of rotational motion are also possible (e.g., at least about 10 degrees and no more than about 300 degrees or at least about 90 degrees and no more than about 180 degrees), inclusive of all values and ranges therebetween. In some embodiments, the shafts 130a, 130b can have a rotational range of motion of about 10 degrees, about 20 degrees, about 30 degrees, about 40 degrees, about 50 degrees, about 60 degrees, about 70 degrees, about 80 degrees, about 90 degrees, about 100 degrees, about 110 degrees, about 120 degrees, about 130 degrees, about 140 degrees, about 150 degrees, about 160 degrees, about 170 degrees, about 180 degrees, about 190 degrees, about 200 degrees, about 210 degrees, about 220 degrees, about 230 degrees, about 240 degrees, about 250 degrees, about 260 degrees, about 270 degrees, about 280 degrees, about 290 degrees, or about 300 degrees.

The linear output connectors 140a, 140b are translated vertically via rotation of the shafts 130a, 130b and further induce vertical motion in the blade attachments, 170a, 170b. In some embodiments, the linear output connectors 140a, 140b can each include a single piece of material. In some embodiments, the linear output connectors 140a, 140b can each include several parts connected together (i.e., the linear output connectors 140a, 140b can each include a cassette of different parts that move up and down). In some embodiments, the linear output connectors 140a, 140b can include cam followers in direct contact with cams or with the shafts 130a, 130b that move up and down based on rotational motion of the shafts 130a, 130b. The linear output connectors 140a, 140b apply force to the blade attachments 170a, 170b with the flexure elements 160a, 160b acting as an intermediary to keep the linear output connectors 140a, 140b in a desired vertical position.

The flexure element 160a is in tension when the linear output connector 140a moves upward or is above a reference vertical position. The flexure element 160b is in tension when the linear output connector 140a is moving downward or is below a reference vertical position. The flexure element 160c is in tension when the linear output connector 140b moves upward or is above a reference vertical position. The flexure element 160d is in tension when the linear output connector 140b is moving downward or is below a reference vertical position. This tensile behavior allows for precise vertical placement of the linear output connectors 140a, 140b, such that they are tightly held in their desired position without the opportunity to wobble. Using the flexure element may beneficially create a low backlash (e.g., about zero backlash) connection which allows the blade 105 to rock while absorbing the coupling force or moment induced by the highly viscous and thereby high shear semi-solid electrode slurry that is being casted and subsequently, smoothened by the doctor blade 105. Moreover, the flexure element 160a (and/or 160b) may also be amenable to cleaning to remove semi-solid electrode material that may get deposited on it during the casting and smoothing process.

The inclusion of two arms in the blade assembly 100 with flexure elements 160a, 160b, 160c, 160d near the terminal ends of the arms offers the doctor blade 105 a degree of freedom, preventing over-constraint of the doctor blade 105. The flexure elements 160a, 160b, 160c, 160d allow force to be transmitted from the shafts 130a, 130b to the doctor blade 105, only placing the flexure elements 160a, 160b, 160c, 160d in tension. In some embodiments, the flexure elements 160a, 160b, 160c, 160d can include slender columns that are intentionally kept out of compression, as they may be subject to buckling under compression (per Euler's slender column formula).

The blade attachments 170a, 170b act as a coupling component between the mounting frame 110 and the doctor blade 105. In some embodiments, the blade attachments 170a, 170b can attach to outside edges or near outside edges of the doctor blade 105. In some embodiments, the blade attachments 170a, 170b can elevate or depress to induce upward or downward motion on either side of the doctor blade 105. In some embodiments, the blade attachments 170a, 170b can be coupled to rotational hubs (not shown). In some embodiments, the hub coupled to the blade attachment 170a can allow for rotational motion and horizontal translation, while the hub coupled to the blade attachment 170b can allow for rotational motion only.

The optional casting nozzle 190 dispenses semi-solid electrode material (e.g., onto a conveyor). In some embodiments, the casting nozzle 190 can be coupled to the doctor blade 105. In some embodiments, the casting nozzle 190 can be coupled to the mounting frame 110. In some embodiments, the casting nozzle 190 can cast the semi-solid electrode material onto a film disposed on the conveyor. In some embodiments, the casting nozzle 190 can cast the semi-solid electrode material onto a current collector disposed on the film. The casting of the casting nozzle 190 can create a large force, thereby inducing a moment in the blade assembly 100. Adjustments made to the doctor blade 105 via movements of the mounting frame 110 can compensate for such a moment. In some embodiments, the cast semi-solid electrode material can move relative to a stationary doctor blade 105. In some embodiments, the doctor blade 105 can move relative to a stationary current collector.

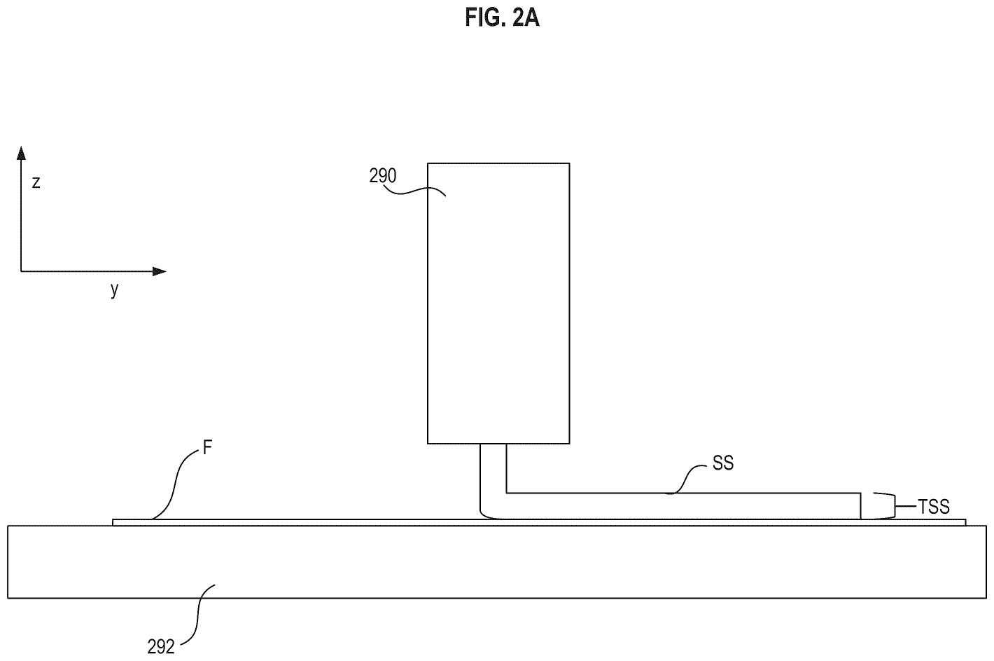

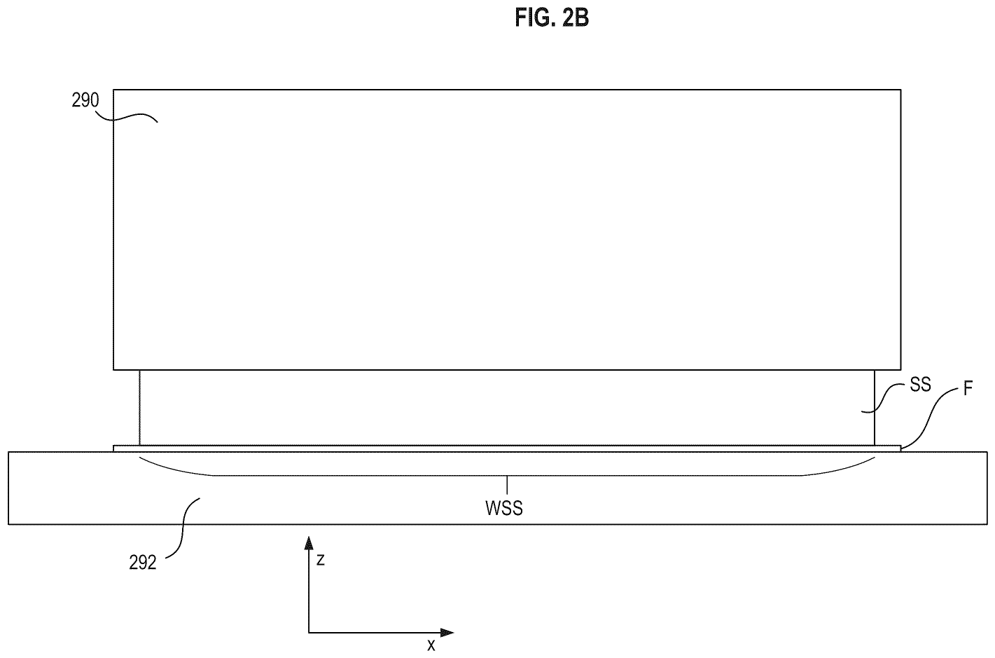

FIGS. 2A-2B are illustrations of a casting nozzle 290 for casting a semi-solid electrode material, according to an embodiment. As shown, the casting nozzle 290 dispenses a semi-solid electrode material SS onto a conveyor 292 with a film F disposed therebetween. In some embodiments, the casting nozzle 290 can be the same or substantially similar to the casting nozzle 190 described above with reference to FIG. 1. In other words, the casting nozzle 290 can be incorporated into a system with a doctor blade and a mounting frame. Thus, certain aspects of the casting nozzle 290 are not described in greater detail herein. Axes are shown for structural clarity. In some embodiments, the casting nozzle 290 can have any of the properties of the casting nozzles described in U.S. Patent Publication No. 2024/0379930 (“the '930 publication), filed Apr. 29, 2024, and titled “Ribbed Electrode Dispensation Nozzles, and Methods of Producing the Same,” the disclosure of which is hereby incorporated by reference in its entirety.

The casting nozzle 290 casts the semi-solid electrode material SS onto the conveyor 292 with significant force. As shown, a film F is disposed on the conveyor 292. In some embodiments, a current collector material (not shown) can be disposed on the film F, such that the semi-solid electrode material SS is disposed onto the current collector material. FIG. 2A shows a side or profile view of the casting nozzle 290 and its casting of the semi-solid electrode material SS. FIG. 2B shows a front view of the casting nozzle 290 and its casting of the semi-solid electrode material SS.

In some embodiments, the semi-solid electrode material SS can include KETJEN BLACK® conductive carbon particles, AA-stacked graphene, AB-stacked graphene, carbon, hard carbon, soft carbon, graphite, lithium iron phosphate (LFP), lithium manganese iron phosphate (LMFP), lithium manganese oxide (LMO), LiNiO₂ (LNO), nickel manganese cobalt (NMC), lithium nickel manganese oxide (LNMO), lithium cobalt oxide (LCO), Iron (III) fluoride (FeF₃), sulfur, vanadium (V) oxide (V₂O₅), bismuth trifluoride (BiF₃), iron (IV) sulfate (FeS₂), or any combination thereof.

In some embodiments, the semi-solid electrode material SS can include an intercalate cathode (e.g., LMOP, LNO, NMC, LFP, LNMO, LCO, and/or LMFP). In some embodiments, the semi-solid electrode material SS can include a convertible cathode (e.g., FeF₃, sulfur, V₂O₅, BiF₃, FeS₂). In some embodiments, the semi-solid electrode material SS can include a high voltage bearable anode. In some embodiments, the semi-solid electrode material SS can include a metal oxide. In some embodiments, the metal oxide can include silicon oxide (SiO), zinc oxide (ZnO), copper oxide (Cu₂O), lithium titanate (LTO), and/or titanium (IV) oxide (TiO₂).

In some embodiments, the semi-solid electrode material SS can include conductive materials. In some embodiments, the semi-solid electrode material SS can include allotropes of carbon including activated carbon, hard carbon, soft carbon, KETJEN BLACK® carbon particles, carbon black, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene, graphene sheets or aggregates of graphene sheets, and materials comprising fullerenic fragments, or any combination thereof.

As shown, the semi-solid electrode material SS is casted with a thickness TSS (i.e., the casted semi-solid electrode material has a thickness TSS). In some embodiments, TSS can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1,000 μm, at least about 1,100 μm, at least about 1,200 μm, at least about 1,300 μm, at least about 1,400 μm, at least about 1,500 μm, at least about 1,600 μm, at least about 1,700 μm, at least about 1,800 μm, or at least about 1,900 μm. In some embodiments, TSS can be no more than about 2,000 μm, no more than about 1,900 μm, no more than about 1,800 μm, no more than about 1,700 μm, no more than about 1,600 μm, no more than about 1,500 μm, no more than about 1,400 μm, no more than about 1,300 μm, no more than about 1,200 μm, no more than about 1,100 μm, no more than about 1,000 μm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced electrode thicknesses are also possible (e.g., at least about 10 μm and no more than about 2,000 μm or at least about 100 μm and no more than about 1,000 μm), inclusive of all values and ranges therebetween. In some embodiments, TSS can be at about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1,000 μm, about 1,100 μm, about 1,200 μm, about 1,300 μm, about 1,400 μm, about 1,500 μm, about 1,600 μm, about 1,700 μm, about 1,800 μm, about 1,900 μm, or about 2,000 μm.

As shown, the semi-solid electrode material SS is casted with a width WSS (i.e., the casted semi-solid electrode material has a width WSS). In some embodiments, WSS can be at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, WSS can be no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced widths are also possible (e.g., at least about 1 cm and no more than about 1 m or at least about 5 cm and no more than about 50 cm), inclusive of all values and ranges therebetween. In some embodiments, WSS can be about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, at least about 50 cm, about 60 cm, about 70 cm, about 80 cm, about 90 cm, or about 100 cm.

The viscosity and density of the semi-solid electrode material SS are both factors in the amount of force the casting of the semi-solid electrode material SS imparts onto the conveyor 292. The viscosity and the density of the semi-solid electrode material SS are related to the solids loading or the active material percentage of the semi-solid electrode material SS. In some embodiments, the semi-solid electrode material SS can have a solids loading of at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, or at least about 85 wt %. In some embodiments, the semi-solid electrode material SS can have a solids loading of no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, or no more than about 25 wt %. Combinations of the above-referenced solids loading compositions are also possible (e.g., at least about 20 wt % and no more than about 90 wt % or at least about 60 wt % and no more than about 85 wt %), inclusive of all values and ranges therebetween. In some embodiments, the semi-solid electrode material SS can have a solids loading of about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt %.

In some embodiments, the semi-solid electrode material SS can have an active material composition of at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, or at least about 85 wt %. In some embodiments, the semi-solid electrode material SS can have an active material composition of no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, or no more than about 25 wt %. Combinations of the above-referenced active material compositions are also possible (e.g., at least about 20 wt % and no more than about 90 wt % or at least about 60 wt % and no more than about 85 wt %), inclusive of all values and ranges therebetween. In some embodiments, the semi-solid electrode material SS can have an active material composition of about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt %.

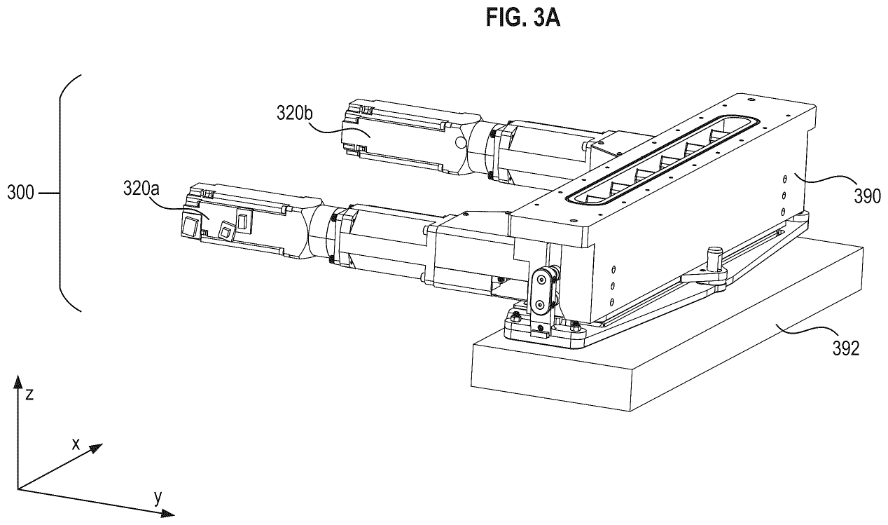

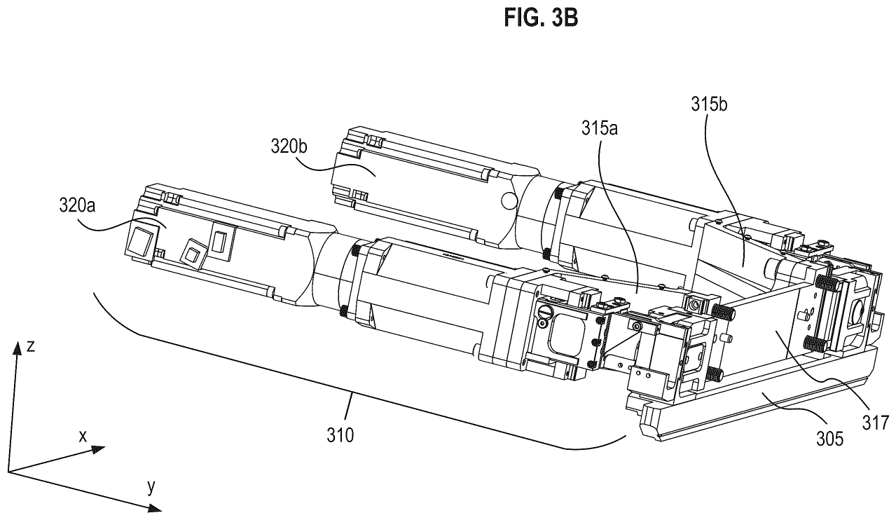

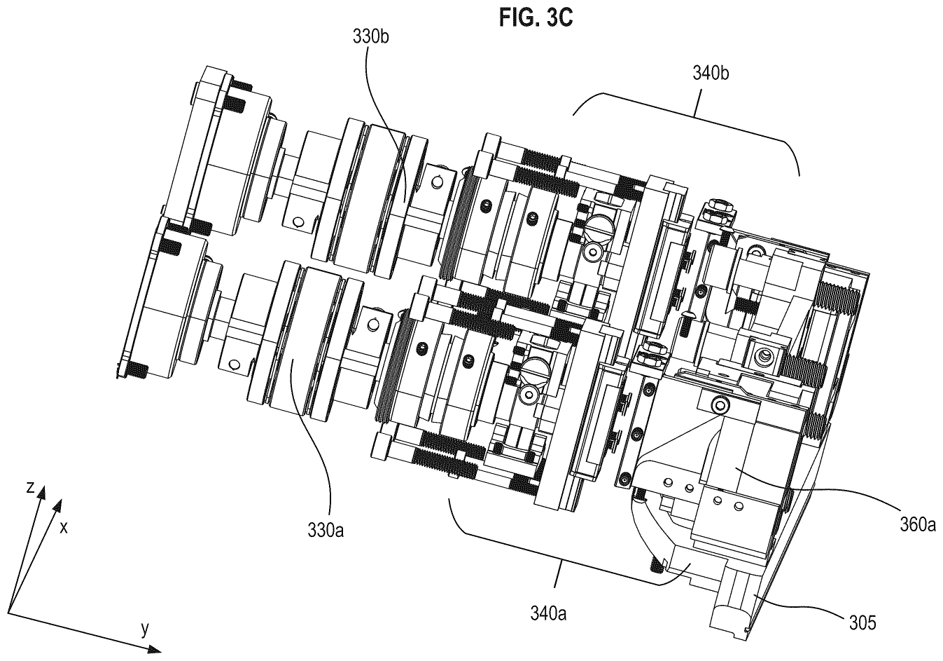

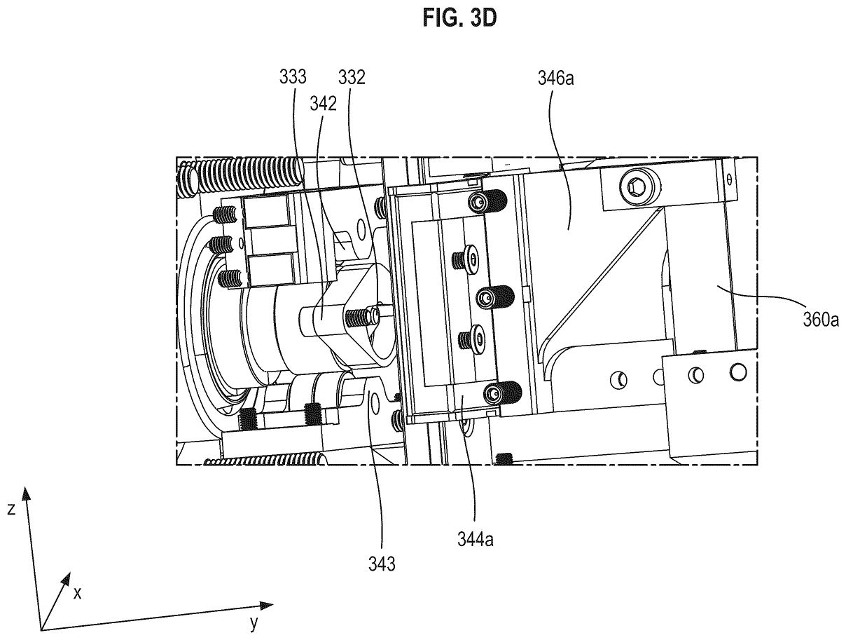

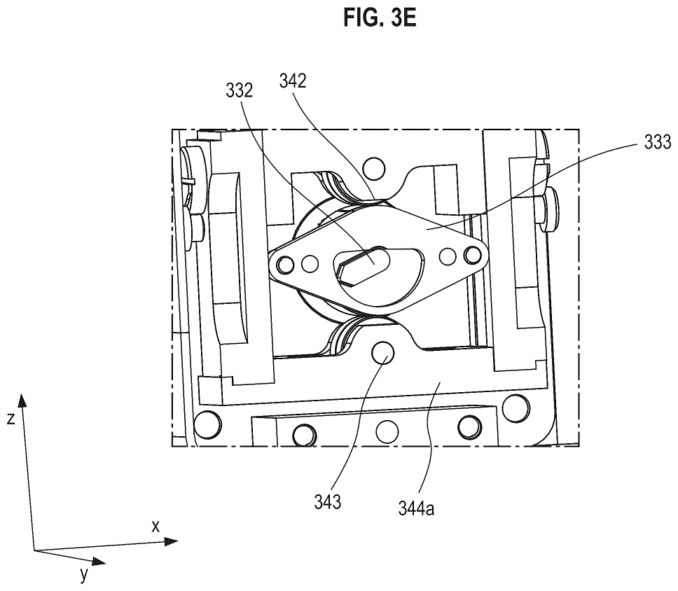

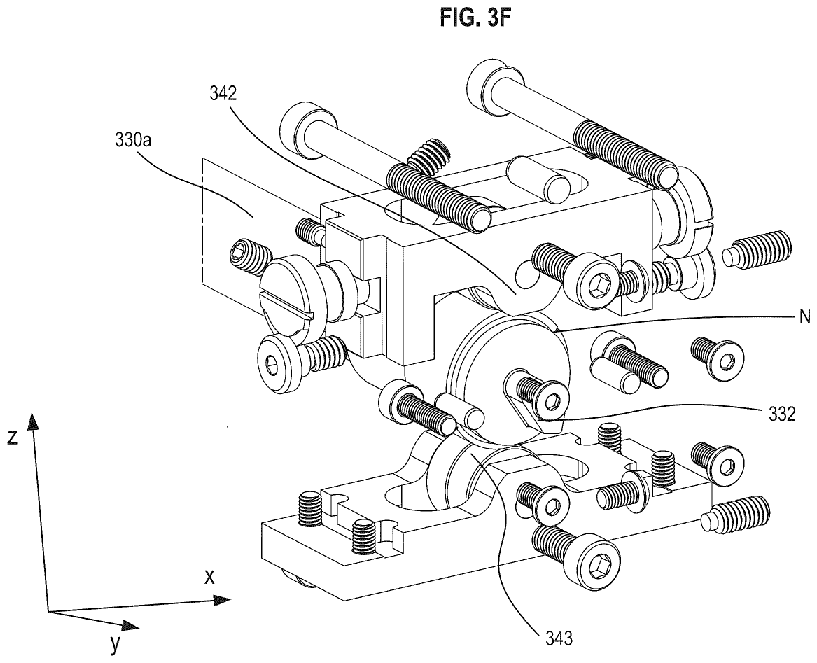

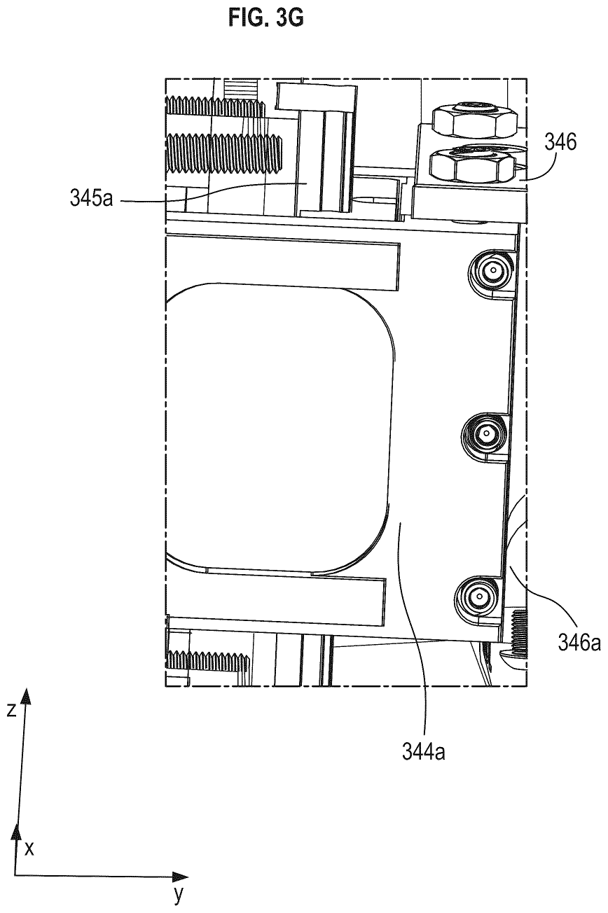

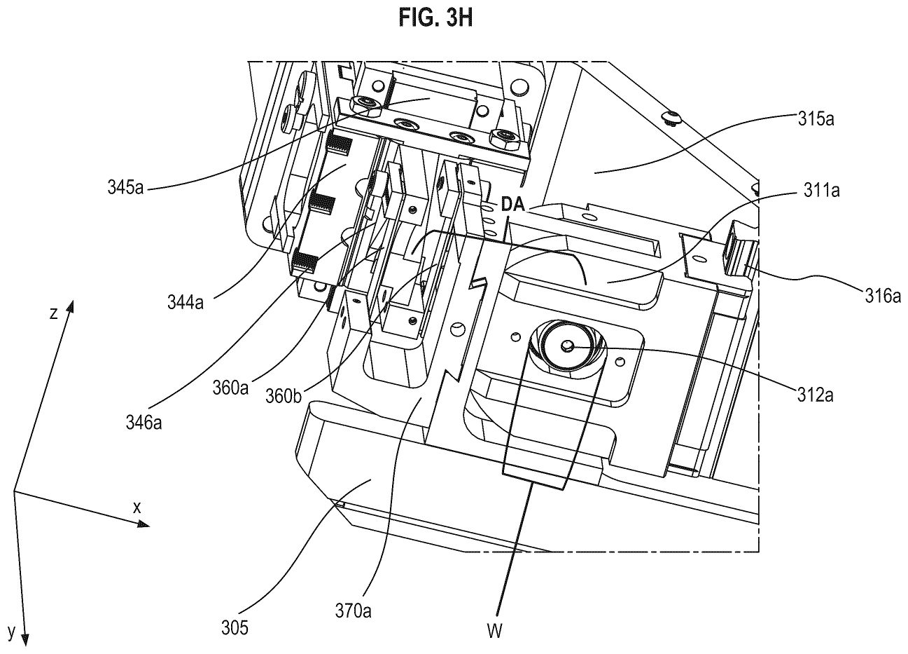

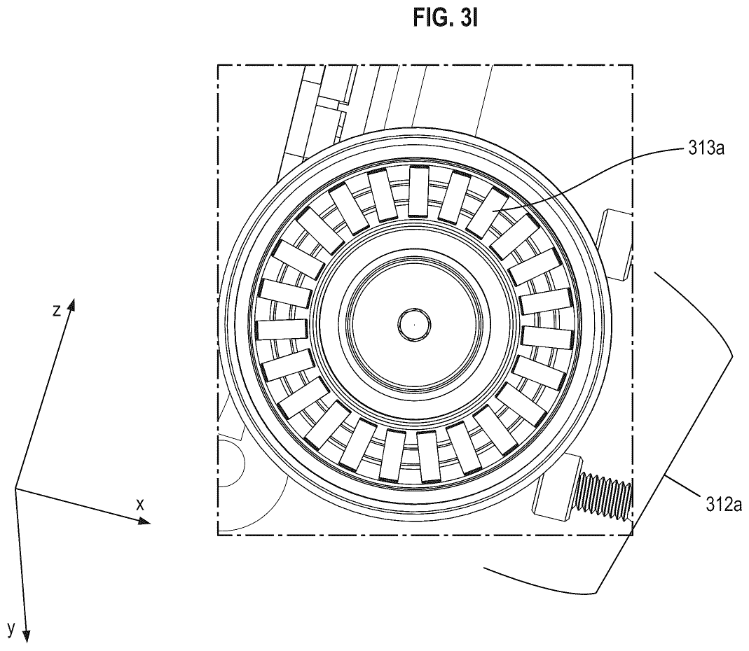

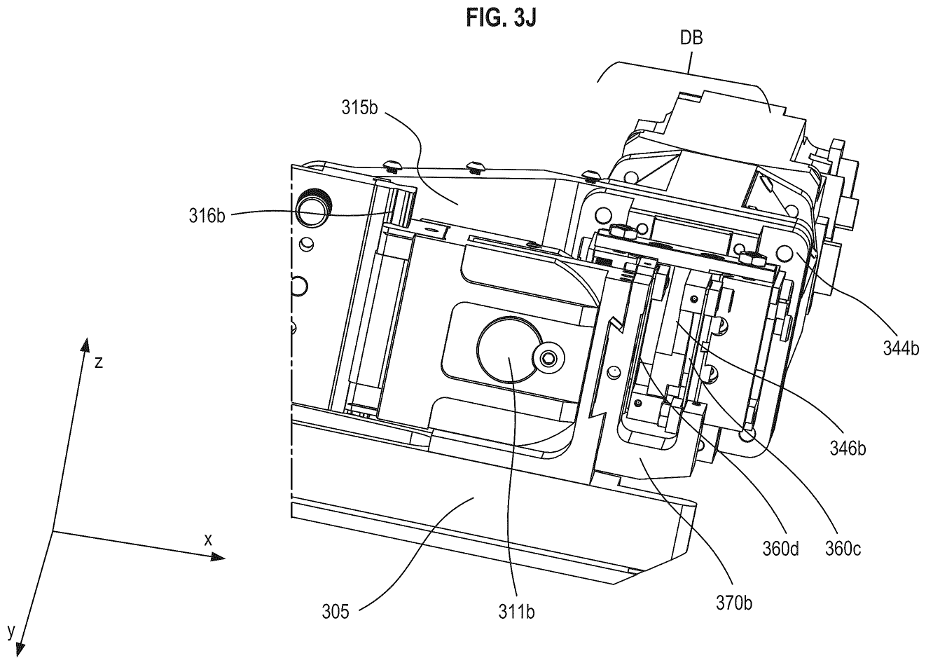

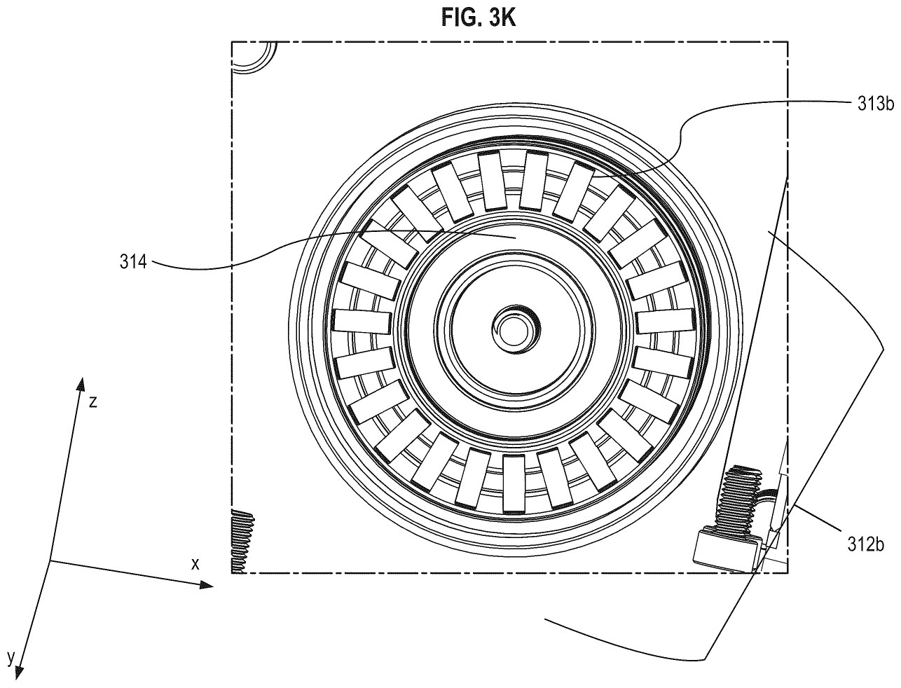

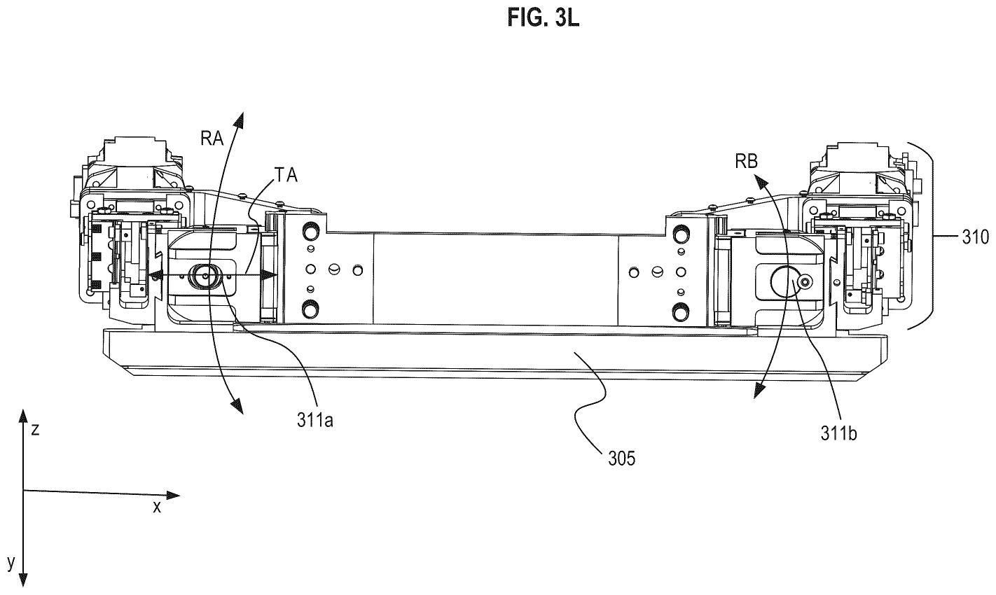

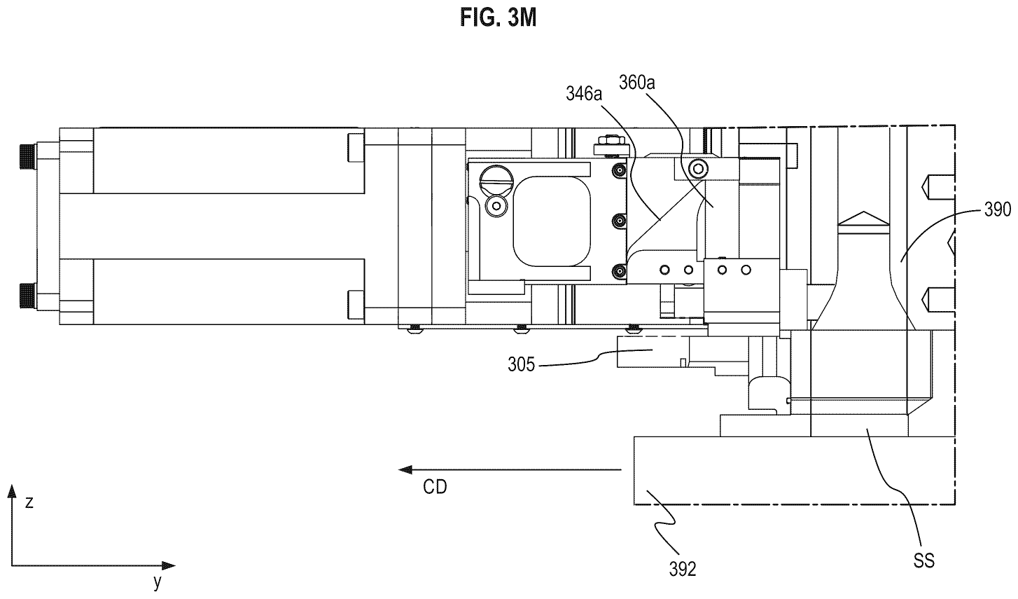

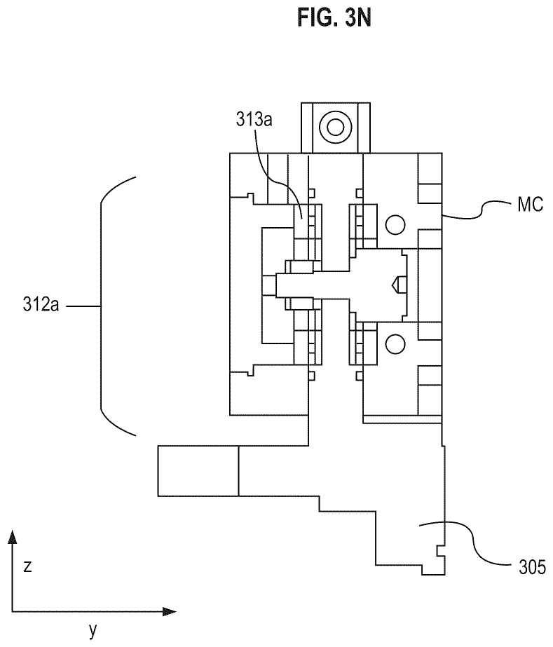

FIGS. 3A-3N are illustrations of a blade assembly 300 for forming a semi-solid electrode, according to an embodiment. As shown, the blade assembly 300 includes a doctor blade 305 and a mounting frame 310. The mounting frame 310 includes two arms, the two arms including actuators 320a, 320b, camshafts 330a, 330b, linear output connectors 340a, 340b, flexure elements 360a, 360b, 360c, 360d, and blade attachments 370a, 370b. The blade assembly 300 includes a casting nozzle 390 attached thereto and is configured to cast semi-solid electrode material onto a conveyor 392. In some embodiments, the doctor blade 305, the mounting frame 310, the actuators 320a, 320b, the camshafts 330a, 330b, the linear output connectors 340a, 340b, the flexure elements 360a, 360b, 360c, 360d, the blade attachments 370a, 370b, and the casting nozzle 390 can be the same or substantially similar to the doctor blade 105, the mounting frame 110, the actuators 120a, 120b, the shafts 130a, 130b, the linear output connectors 140a, 140b, the flexure elements 160a, 160b, 160c, 160d, the blade attachments 170a, 170b, and the casting nozzle 190, as described above with reference to FIG. 1. In some embodiments, the conveyor 392 can be the same or substantially similar to the conveyor 292, as described above with reference to FIGS. 2A-2B. Thus, certain aspects of the doctor blade 305, the mounting frame 310, the actuators 320a, 320b, the camshafts 330a, 330b, the linear output connectors 340a, 340b, the flexure elements 360a, 360b, 360c, 360d, the blade attachments 370a, 370b, the casting nozzle 390, and the conveyor 392 are not described in greater detail herein. Axes are shown in FIGS. 3A-3N for structural clarity.

As shown, the mounting frame 310 includes portions that move vertically, and portions that do not move vertically. Portions that are operably coupled to the linear output connectors 340a, 340b move vertically, while portions that are not operably coupled to the linear output connectors 340a, 340b do not move vertically. FIG. 3A is a perspective view of the full blade assembly 300 and its interaction with the conveyor 392. For visibility purposes, the casting nozzle 390 is removed from FIGS. 3B-3N.

FIG. 3B is a perspective view of the mounting frame 310 and its interaction with the doctor blade 305. As shown, brackets 315a, 315b adjoin portions the mounting frame 310 that do not move vertically. Specifically, the brackets 315a, 315b adjoin casings of the arms of the mounting frame 310 with a face 317 or front surface of the mounting frame 310. These non-mobile or stationary components of the mounting frame provide stable reference points when programming movements of the mobile portions of the mounting frame 310. In general, only the components of the left arm (e.g., the servo motor 320a, the camshaft 330a) are described in greater detail below. In some embodiments, the components of the right arm (e.g., the servo motor 320b, the camshaft 330b) can be the same or substantially similar to the components of the left arm. Therefore, certain aspects of these components are not described again with reference to the right arm. In some embodiments, some of the components of the right arm can be different from components of the left arm. Such embodiments are described in greater detail below.

FIG. 3C is a side view of a front portion of the mounting frame 310 with some of the casing features made transparent for visibility purposes. Visible in FIG. 3C are the camshafts 330a, 330b, the linear output connectors 340a, 340b, one of the flexure elements 360a, and the doctor blade 305.

As shown, the linear output connector 340a is a cassette with multiple interconnected components. FIGS. 3D, 3E, and 3F show interactions between the linear operator connector 340a and its constituent parts with the camshaft 330a and the flexure elements 360a, 360b. FIG. 3D shows details of the linear output connector 340a. As shown, the linear output connector 340a includes an upper cam follower 342 and a lower cam follower 343. The linear output connector 340a further includes a linear output saddle 344a coupled to a flexure base 346a, which couples to the flexure elements 360a, 360b. As shown, the camshaft 330a includes a cam hub 332 and is connected to an overtravel preventer 333.

In FIG. 3D, the linear output saddle 344a is made transparent to show interior detail of the interaction between the camshaft 330a and the linear output connector 340a. As shown, the camshaft hub 332 is disposed at a distal end of the camshaft 330a. The movement of the camshaft hub 332 is inhibited by the overtravel preventer 333. In use, the camshaft 330a contacts the upper cam follower 342 and the lower cam follower 343. As shown, the upper cam follower 342 and the lower cam follower 343 include ball bearings and rollers, such that the upper cam follower 342 and the lower cam follower 343 roll in synchrony with the camshaft 330a. The camshaft 330a has an oblong or elliptical shape, such that the outer surface of the camshaft 330a pushes the linear operator connector 340a upward when a larger radius section of the camshaft 330a contacts the upper cam follower 342. Further, the outer surface of the camshaft 330a pushes the linear operator connector 340a downward when a larger radius section of the camshaft 330a contacts the lower cam follower 343. Differences between radii at different positions along the outside of the camshaft 330a correspond to different lift distances of the linear operator connector 340a. In this way, the camshaft 330a acts as a desmodromic cam. The constant contact between the camshaft 330a and the cam followers 342, 343 creates a conjugate cam system. The preloaded cam follower system allows for zero backlash (i.e., zero lost motion). In other words, each rotation of the camshaft 330a can result in vertical movement of the linear operator connector 340a. This ensures accurate vertical placement of the linear operator connector 340a.

In some embodiments, each arc-second of rotation of the camshaft 330a can correspond to the same vertical movement distance of the linear operator connector 340a. In some embodiments, each arc-second of rotation of the camshaft 330a can correspond to a vertical motion of the linear operator connector of at least about 0.1 nm, at least about 0.2 nm, at least about 0.3 nm, at least about 0.4 nm, at least about 0.5 nm, at least about 0.6 nm, at least about 0.7 nm, at least about 0.8 nm, at least about 0.9 nm, at least about 1 nm, at least about 2 nm, at least about 3 nm, at least about 4 nm, at least about 5 nm, at least about 6 nm, at least about 7 nm, at least about 8 nm, at least about 9 nm, at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, or at least about 900 nm. In some embodiments, each arc-second of rotation of the camshaft 330a can correspond to a vertical motion of the linear operator connector of no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, no more than about 20 nm, no more than about 10 nm, no more than about 9 nm, no more than about 8 nm, no more than about 7 nm, no more than about 6 nm, no more than about 5 nm, no more than about 4 nm, no more than about 3 nm, no more than about 2 nm, no more than about 1 nm, no more than about 0.9 nm, no more than about 0.8 nm, no more than about 0.7 nm, no more than about 0.6 nm, no more than about 0.5 nm, no more than about 0.4 nm, no more than about 0.3 nm, or no more than about 0.2 nm. Combinations of the above-referenced vertical motions are also possible (e.g., at least about 0.1 nm and no more than about 1 μm or at least about 5 nm and no more than about 100 nm), inclusive of all values and ranges therebetween. In some embodiments, each arc-second of rotation of the camshaft 330a can correspond to a vertical motion of the linear operator connector of about 0.1 nm, about 0.2 nm, about 0.3 nm, about 0.4 nm, about 0.5 nm, about 0.6 nm, about 0.7 nm, about 0.8 nm, about 0.9 nm, about 1 nm, about 2 nm, about 3 nm, about 4 nm, about 5 nm, about 6 nm, about 7 nm, about 8 nm, about 9 nm, about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, or about 1 μm.

The overtravel preventer 333 can serve multiple purposes. In some embodiments, the overtravel preventer 333 can block the cam followers 342, 343 from extending beyond an upper or lower bound vertical position. In some embodiments, the overtravel preventer 333 can prevent the cam hub 332 and correspondingly the camshaft 330a from rotating beyond a set of prescribed boundaries. In some embodiments, the outer bounds of rotation of the camshaft 330a, as dictated by the overtravel preventer 333 can serve as calibration points during initial setup of the blade assembly 300. As shown, the cam hub 332 has about 160 degrees of freedom of rotation before the cam hub meets the walls of the overtravel preventer 333. As shown, the camshaft 330a does not make full rotations but oscillates within the bounds set by the overtravel preventer 333. In some embodiments, the camshaft 330a can have the same or substantially similar freedom of rotation to the shafts 130a, 130b, as described above with reference to FIG. 1.

FIG. 3E shows a cross-sectional view of an interaction between the overtravel preventer 333 and the camshaft hub 332. As shown, the overtravel preventer prevents movement of the cam hub 332 and can serve as a backstop for the movement of the linear output connector 340a in either direction. When calibrating, a first travel-restrictive edge of the overtravel preventer 333 can serve as a first outer bound of movement and a second travel restrictive edge of the overtravel preventer 333 can serve as a second outer bound of movement.

In some embodiments, each rotational orientation of the camshaft 330a can correspond to a different vertical position of the linear operator connector 340a. In some embodiments, the linear operator connector 340a can have a vertical range of motion of at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.5 mm, at least about 2 mm, or at least about 2.5 mm. In some embodiments, the linear operator connector 340a can have a vertical range of motion of no more than about 3 mm, no more than about 2.5 mm, no more than about 2 mm, no more than about 1.5 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced ranges of motion are also possible (e.g., at least about 1 μm and no more than about 3 mm or at least about 100 μm and no more than about 1 mm), inclusive of all values and ranges therebetween. In some embodiments, the linear operator connector 340a can have a vertical range of motion of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 1.5 mm, about 2 mm, about 2.5 mm, or about 3 mm.

FIG. 3F shows interactions between the camshaft 330a and the cam followers 342, 343, with parts removed to show detail. As shown, both the upper cam follower 342 and the lower cam follower 343 include rollers to allow for smooth movement of the camshaft. In other words, the rollers on the cam followers 342, 343 allow the cam followers 342, 343 to rotate along with the rotation of the camshaft 330a rather than remaining rotationally stationary during the rotation of the camshaft 330a and creating a frictional hotspot. In some embodiments, the rollers on the cam followers 342, 343 can include ball bearings, or have ball bearings disposed therein. As shown, the camshaft includes a notch N. In the conjugate cam system described herein, the notch can provide an additional reference point. For example, the automated operation of the blade assembly 300 can be configured to treat the notch N as an outer bound of movement, keeping the notch N on a single side of the camshaft 330a between the upper cam follower 342 and the lower cam follower 343. If the operating automation of the blade assembly 300 detects that the upper cam follower 342 is in contact with the notch N, the operating automation can be programmed to not rotate any further toward the upper cam follower 342. If the operating automation of the blade assembly 300 detects that the lower cam follower 342 is in contact with the notch N, the operating automation can be programmed to not rotate any further toward the lower cam follower 342.

FIG. 3G shows the linear output saddle 344a and its interactivity with a linear output sliding track 345a. The linear output saddle 344a is operably coupled to the cam followers 342, 343 and the flexure base 346a. When the cam followers 342, 343 move upward or downward, the linear output saddle 344a moves with them and slides along the sliding track 345a. The sliding track 345a is operably coupled to portions of the mounting frame 310 that do not translate vertically (e.g., the brackets 315a, 315b and/or the face 317).

FIG. 3H shows a frontal view of the left arm of the mounting frame 310, with several components visible. As shown, the flexure base 346a is coupled to flexure elements 360a, 360b. The vertical movement of the linear output connector 340a puts one of the flexure elements 360a, 360b in tension, such that the doctor blade 305 is firmly in its desired position and does not wobble vertically. The flexure element 360a is in tension when the doctor blade 305 is in an elevated position and the flexure element 360b is in tension when the doctor blade 305 is in a depressed position. In some embodiments, the flexure element 360b can be in a relaxed state while the flexure element 360a is in tension. In some embodiments, the flexure element 360a can be in a relaxed state when the flexure element 360b is in tension. In some embodiments, both the flexure element 360a and the flexure element 360b can experience some level of tension. The tension in the flexure elements 360a, 360b propagates along the linear output connector 340a to create a tight, precise fit between the camshaft 330a and the appropriate cam follower 342, 343.

In some embodiments, the flexure element 360a and/or the flexure element 360b can include aluminum, steel, metal, or any other suitable materials. In some embodiments, the flexure element 360a and/or the flexure element 360b can be made from any material that provides a proper stiffness and has an endurance limit preventing fatigue failure. In some embodiments, the flexure element 360a and/or the flexure element 360b can have a modulus of elasticity of at least about 500 MPa, at least about 1 GPa, at least about 2 GPa, at least about 3 GPa, at least about 4 GPa, at least about 5 GPa, at least about 6 GPa, at least about 7 GPa, at least about 8 GPa, at least about 9 GPa, at least about 10 GPa, at least about 20 GPa, at least about 30 GPa, at least about 40 GPa, at least about 50 GPa, at least about 60 GPa, at least about 70 GPa, at least about 80 GPa, at least about 90 GPa, at least about 100 GPa, at least about 200 GPa, at least about 300 GPa, at least about 400 GPa, at least about 500 GPa, at least about 600 GPa, at least about 700 GPa, at least about 800 GPa, or at least about 900 GPa. In some embodiments, the flexure element 360a and/or the flexure element 360b can have a modulus of elasticity of no more than about 1,000 GPa, no more than about 900 GPa, no more than about 800 GPa, no more than about 700 GPa, no more than about 600 GPa, no more than about 500 GPa, no more than about 400 GPa, no more than about 300 GPa, no more than about 200 GPa, no more than about 100 GPa, no more than about 90 GPa, no more than about 80 GPa, no more than about 70 GPa, no more than about 60 GPa, no more than about 50 GPa, no more than about 40 GPa, no more than about 30 GPa, no more than about 20 GPa, no more than about 10 GPa, no more than about 9 GPa, no more than about 8 GPa, no more than about 7 GPa, no more than about 6 GPa, no more than about 5 GPa, no more than about 4 GPa, no more than about 3 GPa, no more than about 2 GPa, or no more than about 1 GPa. Combinations of the above-referenced moduli of elasticity are also possible (e.g., at least about 0.5 GPa and no more than about 1,000 GPa or at least about 20 GPa and no more than about 200 GPa), inclusive of all values and ranges therebetween. In some embodiments, the flexure element 360a and/or the flexure element 360b can have a modulus of elasticity of about 500 MPa, about 1 GPa, about 2 GPa, about 3 GPa, about 4 GPa, about 5 GPa, about 6 GPa, about 7 GPa, about 8 GPa, about 9 GPa, at least about 10 GPa, about 20 GPa, about 30 GPa, about 40 GPa, about 50 GPa, about 60 GPa, about 70 GPa, about 80 GPa, about 90 GPa, about 100 GPa, about 200 GPa, about 300 GPa, about 400 GPa, about 500 GPa, about 600 GPa, about 700 GPa, about 800 GPa, about 900 GPa, or about 1,000 GPa.

As shown in FIG. 3H, the doctor blade 305 is operably coupled to the flexure elements 360a, 360b via the blade attachment 370a. As shown, the blade attachment 370a is coupled to the doctor blade 305 near an outside edge of the blade. A pivot hub 311a acts as an additional coupling hub between the doctor blade 305 and the mounting frame 310. The pivot hub 311a is also slidably coupled to portions of the mounting frame 310 that remain vertically stationary (i.e., the face 317). As shown, the pivot hub 311a is slidably coupled to the face 317 via a hub sliding track 316.

As shown, the pivot hub 311a includes a bearing assembly 312a, allowing the pivot hub 311a to be capable of rotational motion. FIG. 3I shows greater detail of the interior of the hub 311a and the bearing assembly 312a. As shown in FIG. 3H, the bearing assembly includes a nut that is spaced apart laterally from the walls of the pivot hub 311a. In other words, the inner wall space of the pivot hub 311a has a characteristic width W that is wider than a width of the nut of the bearing assembly 312a. The difference between these widths allows for lateral translations of the bearing assembly 312a in the direction of the width of the doctor blade 305, preventing internal loads from developing in the pivot hub 311a when the left arm of the mounting frame 310 moves vertically relative to the right arm of the frame 310. In other words, the bearing assembly 312a has two degrees of freedom: rotational and translational.

As shown, the bearing assembly 312a includes a needle roller thrust bearing 313a. The needle roller thrust bearing 313a allows rotational motion of the bearing assembly 312a. Additionally, the needle roller thrust bearing 313a imparts a preloaded force to the nut of the bearing assembly 312a, preventing backlash when the pivot hub 311a moves vertically. Forces are carried through the bearing assembly 312a to the bearing rail of the bearing assembly 312a.

In some embodiments, the difference between the width W of the opening, in which the nut of the bearing assembly 312a sits and the width of the nut itself (i.e., the nut spacing gap) can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, or at least about 4 cm. In some embodiments, the nut spacing gap can be no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced nut spacing gaps are also possible (e.g., at least about 10 μm and no more than about 5 cm or at least about 1 mm and no more than about 5 cm), inclusive of all values and ranges therebetween. In some embodiments, the nut spacing gap can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, or about 5 cm.

As shown, a distance DA exists between the fulcrum of the left arm of the mounting frame 310 and the axis of rotation of the bearing assembly 312a. This spacing allows the lateral freedom of motion of the bearing assembly 312a when the left arm is elevated or depressed relative to the right arm. In some embodiments, the distance DA can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 15 cm, at least about 20 cm, at least about 25 cm, at least about 30 cm, at least about 35 cm, at least about 40 cm, or at least about 45 cm. In some embodiments, the distance DA can be no more than about 50 cm, no more than about 45 cm, no more than about 40 cm, no more than about 35 cm, no more than about 30 cm, no more than about 25 cm, no more than about 20 cm, no more than about 15 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced distances DA are also possible (e.g., at least about 1 mm and no more than about 50 cm or at least about 1 cm and no more than about 10 cm), inclusive of all values and ranges therebetween. In some embodiments, the distance DA can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 15 cm, about 20 cm, about 25 cm, about 30 cm, about 35 cm, about 40 cm, about 45 cm, or about 50 cm.

FIGS. 3J and 3K show greater detail of the right arm of the mounting frame 310. Visible in FIG. 3J is the doctor blade 305, a linear output saddle 344b, a flexure base 346b, flexure elements 360c, 360d, a blade attachment 370b, a pivot hub 311b, the bracket 315b, and a hub sliding track 316b. In some aspects, components of the right arm can be the same or substantially similar to the components of the right arm and are accordingly not described in greater detail herein. However, the pivot hub 311b has different properties from the pivot hub 311a. As shown, in FIG. 3K, the pivot hub 311b includes a bearing assembly 312b with a needle roller thrust bearing 313b and a ball bearing 314. Similar to the needle roller thrust bearing 313a, the needle roller thrust bearing 313b allows backlash to be removed via a preloaded nut in the bearing assembly 312b. However, the ball bearing 314 (not present in the bearing assembly 312a) prevents translational motion of the bearing assembly. In other words, while the bearing assembly 312a exhibits rotational and horizontally translational freedom along the width of the doctor blade 305, the bearing assembly 312b exhibits rotational freedom while restricting translational freedom. By allowing rotational and translational freedom in one of the hubs while restricting translational freedom in the other hub this prevents load buildup in either of the pivot hubs 311a, 311b while also preventing imprecision due to rocking (i.e., if both hubs have translational freedom, the doctor blade 305 can rock in either direction during vertical movement, causing shaping imprecisions).

As shown, a distance DB exists between the fulcrum of the left arm of the mounting frame 310 and the axis of rotation of the bearing assembly 312b. In some embodiments, the distance DB can be the same or substantially similar to the distance DA. In some embodiments, the distance DB can be different from the distance DA. In some embodiments, the distance DB can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 15 cm, at least about 20 cm, at least about 25 cm, at least about 30 cm, at least about 35 cm, at least about 40 cm, or at least about 45 cm. In some embodiments, the distance DB can be no more than about 50 cm, no more than about 45 cm, no more than about 40 cm, no more than about 35 cm, no more than about 30 cm, no more than about 25 cm, no more than about 20 cm, no more than about 15 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced distances DB are also possible (e.g., at least about 1 mm and no more than about 50 cm or at least about 1 cm and no more than about 10 cm), inclusive of all values and ranges therebetween. In some embodiments, the distance DB can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 15 cm, about 20 cm, about 25 cm, about 30 cm, about 35 cm, about 40 cm, about 45 cm, or about 50 cm.

FIG. 3L visually represents the freedoms of motion of the pivot hub 311a and the pivot hub 311b. As shown, the pivot hub 311a has rotational freedom along rotational axis RA and translational freedom along translational axis TA. The pivot hub 311b has rotational freedom along rotational axis RB but not along a translational axis. FIG. 3M shows a side or profile view of the blade assembly 300 in use, including the casting nozzle 390. As shown, semi-solid electrode material SS is expelled from the casting nozzle 390 and onto the conveyor 392. The conveyor 392 moves along the conveyance direction to bring the semi-solid electrode material SS into contact with the doctor blade 305. The doctor blade 305 removes a portion of the semi-solid electrode material SS, creating a smooth, uniform surface and thickness of the semi-solid electrode material. Adjustments can be made to the doctor blade 305, particularly if the conveyor 392 is uneven (i.e., higher on one side than the other).

FIG. 3N shows the doctor blade 305 and the bearing assembly 312a, and the moment MC created from casting via the casting nozzle 390 (not shown in FIG. 3N). The casting imparts a large force and the adjustments of the doctor blade 305 help reduce and/or eliminate non-uniformities in the thickness or the surface smoothness of the semi-solid electrode material SS. The pivot hubs 311a, 311b and their associated bearing assemblies 312a, 312b absorb moment created by shear force induced by shearing the semi-solid electrode material SS. High shear forces from the doctor blade 305 are supported by the needle roller thrust bearings 313a, 313b. The needle roller thrust bearings 313a, 313b allow backlash to be removed via adjustable preloaded nuts included in the bearing assemblies 312a, 312b. Forces are carried through to the linear bearing rails in the bearing assemblies 312a, 312b. The needle roller thrust bearings 313a, 313b prevent movement in the direction of the moment MC.

In some embodiments, the blade assembly 300 can include a device for thickness monitoring of the semi-solid electrode material SS. In some embodiments, the device for thickness monitoring can include an X-ray monitor. The thickness monitoring can allow adjustment dynamically and accurately as unit cells are tape cast at high conveyance velocities.

In some embodiments, the maximum elevation difference between the left side of the doctor blade 305 and the right side of the doctor blade 305 can be at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, or at least about 4 mm. In some embodiments, the maximum elevation difference between the left side of the doctor blade 305 and the right side of the doctor blade 305 can be no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, or no more than about 2 μm. Combinations of the above-referenced differences are also possible (e.g., at least about 1 μm and no more than about 5 mm or at least about 10 um and no more than about 100 μm), inclusive of all values and ranges therebetween. In some embodiments, the maximum elevation difference between the left side of the doctor blade 305 and the right side of the doctor blade 305 can be about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, or about 5 mm.

In some embodiments, the doctor blade 305 can have a maximum tilt angle of at least about 0.1 degrees, at least about 0.2 degrees, at least about 0.3 degrees, at least about 0.4 degrees, at least about 0.5 degrees, at least about 0.6 degrees, at least about 0.7 degrees, at least about 0.8 degrees, at least about 0.9 degrees, at least about 1 degree, at least about 2 degrees, at least about 3 degrees, at least about.4 degrees, at least about 5 degrees, at least about 6 degrees, at least about 7 degrees, at least about 8 degrees, at least about 9 degrees, at least about 10 degrees, at least about 11 degrees, at least about 12 degrees, at least about 13 degrees, at least about. 14 degrees, at least about 15 degrees, at least about 16 degrees, at least about 17 degrees, at least about 18 degrees, at least about 19 degrees, at least about 20 degrees, at least about 21 degrees, at least about 22 degrees, at least about 23 degrees, at least about.24 degrees, at least about 25 degrees, at least about 26 degrees, at least about 27 degrees, at least about 28 degrees, or at least about 29 degrees. In some embodiments, the doctor blade 305 can have a maximum tilt angle of no more than about 30 degrees, no more than about 29 degrees, no more than about 28 degrees, no more than about 27 degrees, no more than about 26 degrees, no more than 25 degrees, no more than about 24 degrees, no more than about 23 degrees, no more than about 22 degrees, no more than about 21 degrees, no more than about 20 degrees, no more than about 19 degrees, no more than about 18 degrees, no more than about 17 degrees, no more than about 16 degrees, no more than 15 degrees, no more than about 14 degrees, no more than about 13 degrees, no more than about 12 degrees, no more than about 11 degrees, no more than about 10 degrees, no more than about 9 degrees, no more than about 8 degrees, no more than about 7 degrees, no more than about 6 degrees, no more than 5 degrees, no more than about 4 degrees, no more than about 3 degrees, no more than about 2 degrees, no more than about 1 degree, no more than about 0.9 degrees, no more than about 0.8 degrees, no more than about 0.7 degrees, no more than about 0.6 degrees, no more than about 0.5 degrees, no more than about 0.4 degrees, no more than about 0.3 degrees, or no more than about 0.2 degrees. Combinations of the above-referenced maximum tilt angles are also possible (e.g., at least about 0.1 degrees and no more than about 30 degrees or at least about 1 degree and no more than about 20 degrees), inclusive of all values and ranges therebetween. In some embodiments, the doctor blade 305 can have a maximum tilt angle of about 0.1 degrees, about 0.2 degrees, about 0.3 degrees, about 0.4 degrees, about 0.5 degrees, about 0.6 degrees, about 0.7 degrees, about 0.8 degrees, about 0.9 degrees, about 1 degree, about 2 degrees, about 3 degrees, about 0.4 degrees, about 5 degrees, about 6 degrees, about 7 degrees, about 8 degrees, about 9 degrees, about 10 degrees, about 11 degrees, about 12 degrees, about 13 degrees, about. 14 degrees, about 15 degrees, about 16 degrees, about 17 degrees, about 18 degrees, about 19 degrees, about 20 degrees, about 21 degrees, about 22 degrees, about 23 degrees, about.24 degrees, about 25 degrees, about 26 degrees, about 27 degrees, about 28 degrees, about 29 degrees, or about 30 degrees.

In some embodiments, the margin of error for the vertical position of either of the arms of the blade assembly 300 can be less than about 1 μm, less than about 900 nm, less than about 800 nm, less than about 700 nm, less than about 600 nm, less than about 500 nm, less than about 400 nm, less than about 300 nm, less than about 200 nm, less than about 100 nm, less than about 90 nm, less than about 80 nm, less than about 70 nm, less than about 60 nm, less than about 50 nm, less than about 40 nm, less than about 30 nm, less than about 20 nm, less than about 10 nm, less than about 9 nm, less than about 8 nm, less than about 7 nm, less than about 6 nm, less than about 5 nm, less than about 4 nm, less than about 3 nm, less than about 2 nm, less than about 1 nm, less than about 0.9 nm, less than about 0.8 nm, less than about 0.7 nm, less than about 0.6 nm, less than about 0.5 nm, less than about 0.4 nm, less than about 0.3 nm, less than about 0.2 nm, or less than about 0.1 nm, inclusive of all values and ranges therebetween

In some embodiments, the mounting frame 310 can make vertical adjustments to the doctor blade 305 in very short time frames. In some embodiments, the mounting frame 310 can make adjustments to the doctor blade 305 in less than about 10 ms, less than about 9 ms, less than about 8 ms, less than about 7 ms, less than about 6 ms, less than about 5 ms, less than about 4 ms, less than about 3 ms, less than about 2 ms, less than about 1 ms, less than about 900 μs, less than about 800 μs, less than about 700 μs, less than about 600 μs, less than about 500 μs, less than about 400 μs, less than about 300 μs, less than about 200 μs, less than about 100 μs, less than about 90 μs, less than about 80 μs, less than about 70 μs, less than about 60 μs, less than about 50 μs, less than about 40 μs, less than about 30 μs, less than about 20 μs, less than about 10 μs, less than about 9 μs, less than about 8 μs, less than about 7 μs, less than about 6 μs, less than about 5 μs, less than about 4 μs, less than about 3 μs, less than about 2 μs, or less than about 1 μs.

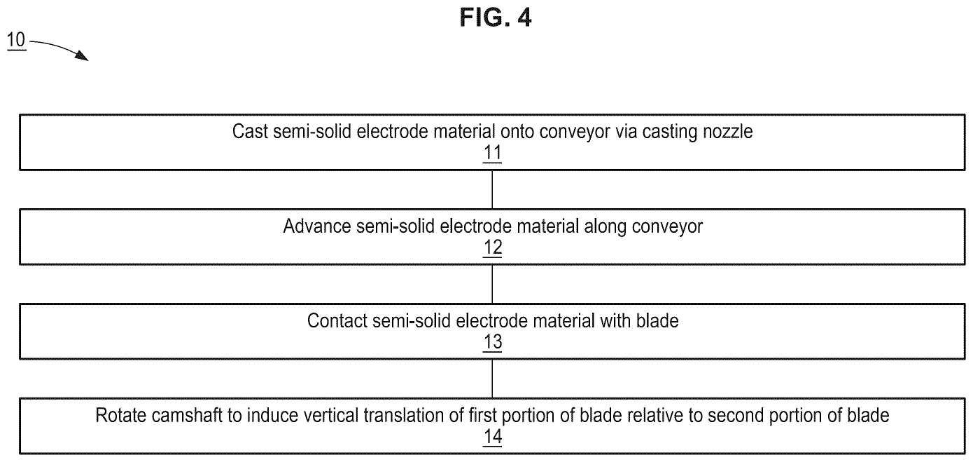

FIG. 4 is a flow diagram of a method 10 of forming a semi-solid electrode, according to an embodiment. As shown, the method 10 includes casting a semi-soldi electrode material onto a conveyor via a casting nozzle at step 11, advancing the semi-soldi electrode material along the conveyor at step 12, contacting the semi-solid electrode material with a doctor blade at step 13, and rotating a shaft to induce vertical translation of a first portion of the doctor blade relative to a second portion of the doctor blade at step 14.

Step 11 includes casting the semi-solid electrode material onto the conveyor via a casting nozzle. In some embodiments, the semi-solid electrode material and/or the casting nozzle can have any of the properties of the semi-solid electrode material SS and the casting nozzle 290, as described above with reference to FIG. 2. In some embodiments, step 11 can include casting the semi-solid electrode material onto a drum (e.g., a drum the same or substantially similar to those described in the '984 patent). In some embodiments, step 11 can include casting the semi-solid electrode material onto a stationary plate.

Step 12 includes advancing the semi-solid electrode material along a conveyor. In some embodiments, the conveyance speed can be at least about 1 mm/s, at least about 2 mm/s, at least about 3 mm/s, at least about 4 mm/s, at least about 5 mm/s, at least about 6 mm/s, at least about 7 mm/s, at least about 8 mm/s, at least about 9 mm/s, at least about 1 cm/s, at least about 2 cm/s, at least about 3 cm/s, at least about 4 cm/s, at least about 5 cm/s, at least about 6 cm/s, at least about 7 cm/s, at least about 8 cm/s, at least about 9 cm/s, at least about 10 cm/s, at least about 20 cm/s, at least about 30 cm/s, at least about 40 cm/s, at least about 50 cm/s, at least about 60 cm/s, at least about 70 cm/s, at least about 80 cm/s, or at least about 90 cm/s. In some embodiments, the conveyance speed can be no more than about 1 m/s, no more than about 90 cm/s, no more than about 80 cm/s, no more than about 70 cm/s, no more than about 60 cm/s, no more than about 50 cm/s, no more than about 40 cm/s, no more than about 30 cm/s, no more than about 20 cm/s, no more than about 10 cm/s, no more than about 9 cm/s, no more than about 8 cm/s, no more than about 7 cm/s, no more than about 6 cm/s, no more than about 5 cm/s, no more than about 4 cm/s, no more than about 3 cm/s, no more than about 2 cm/s, no more than about 1 cm/s, no more than about 9 mm/s, no more than about 8 mm/s, no more than about 7 mm/s, no more than about 6 mm/s, no more than about 5 mm/s, no more than about 4 mm/s, no more than about 3 mm/s, or no more than about 2 mm/s. Combinations of the above-referenced conveyance speeds are also possible (e.g., at least about 1 mm/s and no more than about 1 m/s or at least about 5 mm/s and no more than about 20 cm/s), inclusive of all values and ranges therebetween. In some embodiments, the conveyance speed can be about 1 mm/s, about 2 mm/s, about 3 mm/s, about 4 mm/s, about 5 mm/s, about 6 mm/s, about 7 mm/s, about 8 mm/s, about 9 mm/s, about 1 cm/s, about 2 cm/s, about 3 cm/s, about 4 cm/s, about 5 cm/s, about 6 cm/s, about 7 cm/s, about 8 cm/s, about 9 cm/s, about 10 cm/s, about 20 cm/s, about 30 cm/s, about 40 cm/s, about 50 cm/s, about 60 cm/s, about 70 cm/s, about 80 cm/s, about 90 cm/s, or about 100 cm/s.

Step 13 includes contacting the semi-solid electrode material with a doctor blade. The doctor blade shapes the electrode material and can create uniformity in smoothness and thickness of the electrode material. The shearing of the semi-solid electrode material via the doctor blade creates a moment that can be absorbed via machinery coupled to the doctor blade.

Step 14 includes rotating a shaft to induce a vertical translation of a first portion of a doctor blade relative to a second portion of the doctor blade. In some embodiments, the shaft can include a camshaft. In some embodiments, step 14 can include inducing a tilt or a cant in the doctor blade. In some embodiments, the camshaft can be a first camshaft, and the method 10 can include rotating a second camshaft to induce a vertical translation of the second portion of the doctor blade. In some embodiments, the vertical translation of the second portion of the doctor blade can be different from the vertical translation of the first portion of the doctor blade. In some embodiments, the rotation of the shaft can induce vertical motion of a linear output connector operably coupled to the doctor blade. In some embodiments, the method 10 can include applying a tension to the linear output connector in a direction opposite the direction of the vertical translation of the first portion of the doctor blade. The tension can enable precision of vertical placement of the first portion of the doctor blade and minimize error.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A blade assembly, comprising:
a doctor blade;
a mounting frame, the mounting frame including:
a blade attachment coupled to a first portion of the doctor blade, the blade attachment configured to impart vertical translations to the first portion of the doctor blade, such that the first portion of the doctor blade is at a different elevation from a second portion of the doctor blade;
a first flexure element coupled to the blade attachment;
a second flexure element coupled to the blade attachment;
a linear output connector coupled to the first flexure element and the second flexure element, the linear output connector configured to impart a tensile force to the first flexure element when the linear output connector is at a first elevation, the linear output connector configured to impart a tensile force to the second flexure element when the linear output connector is at a second elevation, the second elevation lower than the first elevation;
a camshaft operably coupled to the linear output connector and configured to rotate to impart vertical motion to the linear output connector; and
an actuator operably coupled to the camshaft and configured to impart rotational motion to the camshaft.

2. The blade assembly of claim 1, wherein the blade attachment is a first blade attachment, the linear output connector is a first linear output connector, the camshaft is a first camshaft, and the actuator is a first actuator, the mounting frame further including:
a second blade attachment coupled to the second portion of the doctor blade, the second blade attachment configured to impart vertical translations to the second portion of the doctor blade;
a third flexure element coupled to the second blade attachment;
a fourth flexure element coupled to the second blade attachment;
a second linear output connector coupled to the third flexure element and the fourth flexure element, the second linear output connector configured to impart a tensile force to the third flexure element when the second linear output connector is at a first elevation, the second linear output connector configured to impart a tensile force to the fourth flexure element when the second linear output connector is at a second elevation, the second elevation lower than the first elevation;
a second camshaft operably coupled to the second linear output connector and configured to rotate to impart vertical motion to the second linear output connector; and
a second actuator operably coupled to the second camshaft and configured to impart rotational motion to the second camshaft.

3. The blade assembly of claim 2, further comprising:
a first pivot hub slidably coupled to the mounting frame and rotatably coupled to the doctor blade, such that the doctor blade has rotational freedom of motion about a first axis of rotation through the first pivot hub and translational freedom of motion along a width of the first pivot hub.

4. The blade assembly of claim 3, further comprising:
a second pivot hub slidably coupled to the mounting frame and rotatably coupled to the doctor blade, such that the doctor blade has rotational freedom of motion about a second axis of rotation through the second pivot hub.

5. The blade assembly of claim 4, wherein the doctor blade does not have translational freedom of motion along the width of the second pivot hub.

6. The blade assembly of claim 3, wherein the first axis of rotation is offset from the first portion of the doctor blade by a first offset distance, the first offset distance configured to change as the doctor blade translates along the width of the first pivot hub.

7. The blade assembly of claim 4, wherein the second axis of rotation is offset from the second portion of the doctor blade by a second offset distance.

8. The blade assembly of claim 1, further comprising:
a casting nozzle coupled to at least one of the doctor blade or the mounting frame, the casting nozzle configured to dispense a semi-solid electrode material.

9. A method, comprising:
casting a semi-solid electrode material onto a conveyor via a casting nozzle;
advancing the semi-solid electrode material along the conveyor;
contacting semi-solid electrode material with a doctor blade;
rotating a coupler to induce a vertical translation of a first portion of the doctor blade relative to a second portion of the doctor blade, such that the doctor blade has a non-uniform vertical position along a width of the doctor blade while contacting the semi-solid electrode material.

10. The method of claim 9, wherein the coupler includes a camshaft.

11. The method of claim 10, wherein the camshaft is a first camshaft, the method further comprising:
rotating a second camshaft to induce a vertical translation of the second portion of the doctor blade.

12. The method of claim 10, wherein rotating the camshaft induces vertical motion of a linear output connector, the linear output connector operably coupled to the first portion of the doctor blade.

13. The method of claim 12, wherein the linear output connector is operably connected to the first portion of the doctor blade via a blade attachment.

14. The method of claim 12, further comprising:
applying a tension to the linear output connector in a direction opposite the direction of the vertical translation of the first portion of the doctor blade.

15. A blade assembly, comprising:
a blade;
a mounting frame, the mounting frame including:
a linear output connector operably coupled to a first portion of the blade, the linear output connector configured to impart vertical translations to the first portion of the blade, such that the first portion of the blade is at a different elevation from a second portion of the blade;
a shaft operably coupled to the linear output connector and configured to rotate to impart vertical motion to the linear output connector; and
an actuator operably coupled to the shaft and configured to impart rotational motion to the shaft.

16. The blade assembly of claim 15, wherein the shaft includes a camshaft.

17. The blade assembly of claim 15, further comprising:
a biasing member coupled to the blade and the mounting frame, the biasing member configured to apply a force to the mounting frame to maintain a separation distance between the blade and the mounting frame.

18. The blade assembly of claim 15, wherein the linear output connector is a first linear output connector, the shaft is a first shaft, and the actuator is a first actuator, the mounting frame further including:
a second linear output connector operably coupled to a second portion of the blade, the linear output connector configured to impart vertical translations to the second portion of the blade, such that the second portion of the blade changes elevation;
a second shaft operably coupled to the linear output connector and configured to rotate to impart vertical motion to the second linear output connector; and
a second actuator operably coupled to the second shaft and configured to impart rotational motion to the second shaft.

19. The blade assembly of claim 18, further comprising:
a first pivot hub slidably coupled to the mounting frame and rotatably coupled to the blade such that the blade has rotational freedom of motion about a first axis of rotation through the first pivot hub and translational freedom of motion along a width of the first pivot hub.

20. The blade assembly of claim 19, further comprising:
a second pivot hub slidably coupled to the mounting frame and rotatably coupled to the blade, such that the blade has rotational freedom of motion about a second axis of rotation through the second pivot hub.

21. The blade assembly of claim 20, wherein the blade does not have translational freedom of motion along the width of the second pivot hub.
